(19) United States
(12) Patent Application Publication
(10) Pub. No.: US 2006/0110709 A1
(43) Pub. Date: May 25, 2006

(54) Malleable floss for cleaning dental implants

(76) Inventor: Kenneth E. Clark JR., Jacksonville, FL (US)

Correspondence Address: Mark J. Young;Suite 227, 9951 Atlantic Blvd., Jacksonville, FL, 32225, US

(21) Appl. No.: 10/993,773

(22) Filed: Nov. 20, 2004

(51) Int. Cl. A61C 15/00

(52) U.S. Cl. 433/216; 132/321

(57) ABSTRACT

A malleable dental floss includes a thin malleable strand. The strand has a pair of end sections and an intermediate section. A thin pliable end section coating covers each end section. A pliable flossing material covers the intermediate section. Each end section has a thin pliable coating may have a tapered end. The flossing material may include a yarn, polyester, cotton, silk, nylon, rayon, orlon, dacron, caron, glass fiber, wool, elastomer or plastic. An end may be bent. The bent end may be positioned between a gum line and dental implant to captively engage a portion of the periphery of a dental implant post. A user may grasp the free end of the bent end and pull it outwardly to commence flossing.

### BACKGROUND OF THE INVENTION

1. Field of the Invention

This invention generally relates to dental implants, and, more particularly, to a malleable floss for cleaning dental implants.

2. Background Description

As can be seen by reference to the following U.S. Pat. Nos. 3,896,824; 4,142,538; 4,265,258; and, 5,063,948, the prior art is replete with myriad and diverse malleable floss.

While all of the aforementioned prior art constructions are more than adequate for the basic purpose and function for which they have been specifically designed, they are uniformly deficient with respect to their failure to provide a simple, efficient, and practical malleable floss that is specifically designed to clean the posts that support dental implants.

As most dental implant wearers are all too well aware, a crucial part of the their dental hygiene regimen involves removing trapped food particles and plaque that are deposited on and build up around the metal posts that support the dental implant. It is extremely difficult for a wearer to wrap or hook conventional floss around metal posts of dental implants because the floss does not retain a hooked shape when bent. While the ends of the floss described in U.S. Pat. No. 6,644,323 can retain a hooked shape, the central section is flaccid, which severely impedes manipulation of the bent end section. Additionally, although the floss disclosed in the 6,644,323 patent is an advancement for cleaning dental posts, its construction is complex and manufacture is cumbersome and costly.

As a consequence of the foregoing, there exists a longstanding need among people having dental implants for a new and improved floss that facilitates engaging and cleaning dental implant support posts to remove food particles and plaque without causing damage. The invention is directed to overcoming one or more of the problems as set forth above.

### SUMMARY OF THE INVENTION

To overcome problems as set forth above, in one aspect of the invention a malleable dental floss comprising a thin malleable strand is provided. The strand has a pair of end sections and an intermediate section. A thin pliable end section coating covers each end section. A pliable flossing material covers the intermediate section. Each end section may have a thin pliable coating has a tapered end. The malleable dental floss may be comprised of yarn, polyester, cotton, silk, nylon, rayon, orlon, dacron, caron, glass fiber, wool, an elastomer or plastic.

In one aspect of an exemplary embodiment of the invention, the malleable dental floss has an average diameter of approximately 0.28 mm to 1.0 mm, an average overall diameter of approximately 0.5 mm to 3.0 mm, a total length of approximately 50 mm to 300 mm, and end sections of equal length.

In yet another aspect of an exemplary embodiment of the invention, he malleable dental floss may include an active substance functionally applied to the flossing material. The active substance may comprise a flavorant, medicant, anti-bacterial agent, coagulant, fluoride compound, antibiotic, anti-inflammatory agent, anticalculus agent, desensitizing agent, local anesthetic agent and/or polishing agent.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of a malleable floss according to an exemplary embodiment of the invention;

FIG. 2 is an isolated perspective view of a malleable floss according to an exemplary embodiment of the invention;

FIG. 3 is a cross-sectional view of an end sections taken through line 3-3 of FIG. 2 for a malleable floss according to an exemplary embodiment of the invention;

FIG. 4 is a cross-sectional view of an intermediate section taken through line 4-4 of FIG. 2 for a malleable floss according to an exemplary embodiment of the invention; and

FIGS. 5 through 5c illustrate a manipulation of a malleable floss according to an exemplary embodiment of the invention to clean the periphery of a dental implant support post; and

FIG. 6 shows a side profile view of exemplary malleable floss according to principles of the invention after applying a thin pliable outer layer, but before flossing material is applied to the intermediate section.

### DETAILED DESCRIPTION

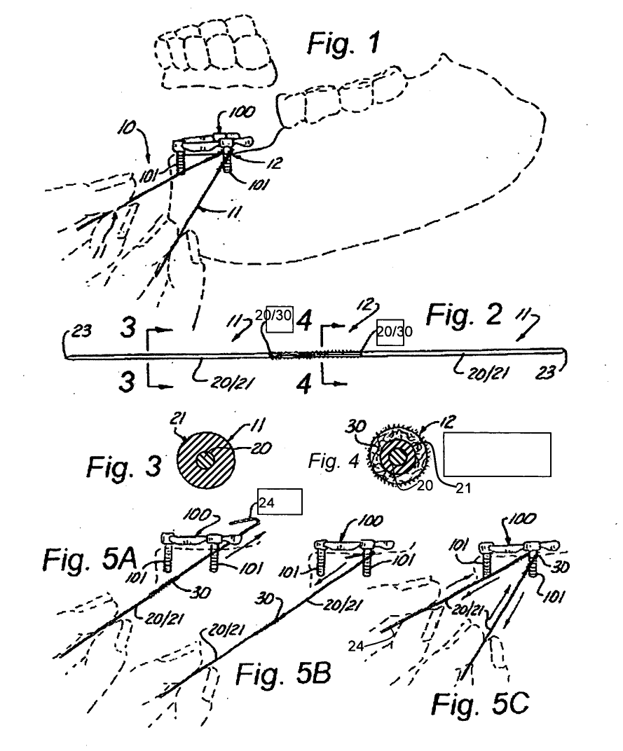

As shown in the drawings, and in particular FIG. 1, malleable floss that forms the basis of an exemplary embodiment of the invention is designated generally by the reference number 10. The malleable floss 10 comprises in general a pair of end sections 11 and an intermediate section 12. These sections will now be described in greater detail below.

Now referring to FIGS. 2 and 3, each of the exemplary end sections 11 comprises a thin strand of deformable wire 20 coated with a generally thin pliable outer layer 21. By way of example and not limitation, outer layer 21 coatings may include hard or soft plastics, polymers, rubbers, elastomers, polyurethane, polypropylene, polyethylene, bakelite, cellophane, polyolefin, silicones, and other non-toxic pliant coating materials. The thickness of the coating may vary, the limitation being that the malleable floss 10 should be thin enough to easily fit between a gumline and dental implant. The composite structure 20/21 may have a tapered outboard end 23 covered with the coating to facilitate threading the end through a gap between a dental implant and gumline without causing injury to the gum.

Referring now to FIGS. 2 and 4, it can be seen that the intermediate section 12 comprises the thin strand of deformable wire 20, a pliable intermediate layer 21 and an outer coating comprised of a suitable dental flossing material 30. The intermediate layer 21 disposed between the wire 20 and flossing material 30 may be the same material as that of the thin pliable outer layer 21 of the end sections 11. However, in a preferred implementation, a thinner layer of such material is applied over the intermediate section 12, so that when the flossing material 30 is applied over the intermediate layer 21, the diameter of the intermediate section 12 is approximately the same as the diameter of each end section. The flossing material 30 is comprised of a bio-compatible substance that can be applied onto the wire strand 20 for use in flossing in accordance with the principles of the invention. By way of example and not limitation, yarn, polyester, cotton, silk, nylon, rayon, orlon, dacron, caron, glass fiber, wool, an elastomer or plastic (textured or untextured), or other suitable dental scrubbing material may be used. The flossing material 30 may affixed to the wire 20 of the intermediate section 12 by chemical or thermal bonding or the like.

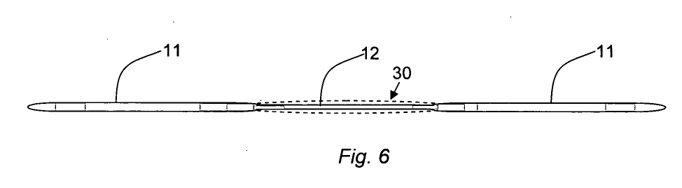

Illustratively, FIG. 6 shows a side profile view of an exemplary malleable floss after applying thin pliable outer layer 21, but before flossing material is applied to the intermediate section 12. The wire strand 20 preferably has a consistent diameter from end 11 to end 11, and through the intermediate section 12. The thin pliable outer layer 21 applied over the ends 11 has a greater thickness than the thin pliable outer layer 21 applied over the intermediate section 12. The dotted lines correspond to the thickness of the floss material 30, which is applied as the outer layer of the intermediate section 12.

The thin strand of deformable wire 20 may be comprised of various malleable bio-compatible materials. By way of example and not limitation non-toxic, thin, malleable strands of stainless steel, alloys of nickel-titanium, nickel-molybdenum, or nickel-copper-titanium, aluminum, brass, gold, alkali metal, britannia metal, alkaline earth metal, titanium, nylon, copper, silver and alloys thereof may be used. Those skilled in the art will appreciate that the particular composition of the wire 20 is not important so long as the wire 20 is non-toxic, can be formed into a thin strand and exhibits physical properties consistent with the principles of the invention (e.g., good structural integrity and malleability). Preferably, the material is also relatively inexpensive, abundant and suitable for use in conventional manufacturing operations.

The wire 20 is sized such that the malleable floss 10 will fit in the space between a dental implant and gumline. In an exemplary embodiment, the malleable wire 20 is approximately 0.28 mm to 1 mm in diameter, or approximately 19 to 30 gauge (AWG) wire. The diameter may be constant or vary slightly along the length of the wire, in which case the range provided above may correspond to an average diameter. However, those having skill in the art will appreciate that wires of other dimensions and configurations may be used without departing from the scope of the invention, so long as when the wire receives a functionally adequate coating (as described herein) the coated structure fits between a dental implant and gumline.

Likewise, coating thicknesses are sized such that the malleable floss 10 will fit in the space between a dental implant and gumline. In an exemplary implementation, the product thickness including wire and coatings should be between approximately 0.5 mm and 3.0 mm in diameter. The product thickness may be constant or vary along the length of the malleable floss 10, in which case the range provided above may correspond to an average diameter.

The length of the wire 20 should provide an adequate intermediate section length 12 for flossing a dental implant post and adequate end section lengths 11 for reaching the post and for gripping manipulation of the ends. In an exemplary embodiment, the total length is approximately 50 mm to 300 mm, with the intermediate section 12 comprising approximately ¼ to ½ of the total length and the end sections 11 being approximately equal to each other in length.

Malleable floss 10 according to principles of the invention can be straightened, as in FIG. 2, or any and all of its portions can be freely deformed (i.e., bent) to any of various shapes, such as those shown in FIGS. 5A to 5C. Deformed portions will retain their shapes until forcibly displaced therefrom. Thus, a user can manipulate various portions to achieve positions that facilitate reaching and engaging a dental implant structure that requires flossing.

Referring now to FIGS. 5A through 5C, the malleable floss 10 is employed to clean a support post 101 of a dental implant 100. An outboard end 24 of one of the end sections 11 is bent into a generally L-shaped, U-shaped, V-shaped or like configuration. Because the malleable wire 20 extends centrally through the intermediate section 12 as well as through both end sections 11, the entire malleable floss retains its shape. Thus, the bent end 24 may be extended into a person's mouth and inserted between a person's gum line and the dental implant 100 adjacent one of the support posts 101 as shown in FIG. 5A so that the bent portion captively engages a portion of the periphery of the post 101 as shown in FIG. 5B. Thus, the free bent end 24 may be grasped and withdrawn in a direction away from the user's mouth. A user may position the length of floss material 30 adjacent to the support post 101 by grasping the free end of the bent end 24 and pulling it outwardly from the mouth. Upon being pulled, the bent end 24 will straighten as shown in FIG. 5C. When the length of floss material 30 is positioned adjacent to the support post 101, the user may clean the post 101 by a back and forth reciprocation of the end sections 11, thereby causing the intermediate section 12 to scrub the periphery of the support post 101 and remove food particles and plaque therefrom.

In another embodiment, malleable floss 10 according to principles of the invention can be coated with various active substances. By way of example and not limitation, flavorants, medicants, anti-bacterial agents, coagulants, fluorides, antibiotics, anti-inflammatory agents, anticalculus agents, desentisizing agents, local anesthetic agents and/or polishing agents. The active substances can be applied to the exterior surface of the intermediate section 12 of the malleable floss 10 as a spray, liquid or slurry and dried thereon or otherwise incorporated into the floss material 30. Thus, in addition to effectively cleaning dental implants, the malleable floss may be used to deliver active agents to hard to reach areas of dental implants.

In yet another exemplary embodiment, the malleable floss 10 may include colored coatings and/or floss materials. For example, blue, green, purple, orange, red, yellow, gray, white, black, turquoise, brown, tan, silver, burgundy, pink, and florescent colors may be used. The color may be provided for aesthetic reasons and/or for functional purposes such as to indicate the size, composition or included active agents of the malleable floss 30.

Advantageously, malleable floss according to the principles of the invention may be packaged and marketed in a conventional manner, such as using a blister card, clam shell, shelf box, auto-bag, shrink wrap, cardboard box, soft and hard coverings, glass containers, polystyrene, sacks, bags, jar, bottle, tubes, and bubble packs.

While the invention has been described in terms of various embodiments, implementations and examples, those skilled in the art will recognize that the invention can be practiced with modification within the spirit and scope of the appended claims including equivalents thereof. The foregoing is considered as illustrative only of the principles of the invention. Variations and modifications may be affected within the scope and spirit of the invention.

What is claimed is:

1. A malleable dental floss comprising
a thin malleable strand, said strand having a pair of end sections and an intermediate section;
a first pliable coating over each end section and the intermediate section; and
a pliable flossing material covering the first pliable coating over the intermediate section.

2. The malleable dental floss as in claim 1, wherein the first pliable coating over each end section has a first average thickness and the first pliable coating over the intermediate section has a second average thickness, said second average thickness being less than the first thickness.

3. The malleable dental floss as in claim 1, wherein said malleable strand is comprised of a material from the group consisting of
stainless steel;
alloys of nickel-titanium, nickel-molybdenum, or nickel-copper-titanium
aluminum;
brass;
gold;
alkali metal;
britannia metal;
alkaline earth metal;
titanium;
nylon;
copper; and
silver.

4. The malleable dental floss as in claim 1, wherein each end section that has a thin pliable coating has a tapered end.

5. The malleable dental floss as in claim 1, wherein the flossing material is a material from the group consisting of yarn, polyester, cotton, silk, nylon, rayon, orlon, dacron, caron, glass fiber, wool, an elastomer and plastic.

6. The malleable dental floss as in claim 1, wherein the malleable strand has an average diameter of approximately 0.28 mm to 1.0 mm.

7. The malleable dental floss as in claim 1, wherein the malleable dental floss has an average diameter of approximately 0.5 mm to 3.0 mm.

8. The malleable dental floss as in claim 1, wherein the malleable dental floss has a total length of approximately 50 mm to 300 mm.

9. The malleable dental floss as in claim 1, wherein the malleable dental floss has a total length is approximately 50 mm to 300 mm, the intermediate section is approximately ¼ to ½ of the total length and each end section is approximately equal in length to the other end section.

10. The malleable dental floss as in claim 1, further comprising an active substance functionally applied to the flossing material, said active substance comprising a substance from the group consisting of a flavorant, medicant, anti-bacterial agent, coagulant, fluoride compound, antibiotic, anti-inflammatory agent, anticalculus agent, desensitizing agent, local anesthetic agent and polishing agent.

11. The malleable dental floss as in claim 1, further comprising a packaging from the group consisting of a blister card, clam shell, shelf box, auto-bag, shrink wrap, cardboard box, soft covering, hard covering, glass container, polystyrene, sack, bag, jar, bottle, tube and bubble pack.

12. The malleable dental floss as in claim 2, wherein each end section has a tapered end.

13. The malleable dental floss as in claim 12, wherein the flossing material is a material from the group consisting of yam, polyester, cotton, silk, nylon, rayon, orlon, dacron, caron, glass fiber, wool, an elastomer and plastic.

14. The malleable dental floss as in claim 12, wherein the malleable strand has an average diameter of approximately 0.28 mm to 1.0 mm.

15. The malleable dental floss as in claim 13, wherein the malleable dental floss has an average diameter of approximately 0.5 mm to 3.0 mm.

16. The malleable dental floss as in claim 14, wherein the malleable dental floss has a total length is approximately 50 mm to 300 mm.

17. The malleable dental floss as in claim 15, wherein the malleable dental floss has a total length is approximately 50 mm to 300 mm, the intermediate section is approximately ¼ to ½ of the total length and each end section is approximately equal in length to the other end section.

18. The malleable dental floss as in claim 16, wherein the malleable dental floss has a total length is approximately 50 mm to 300 mm, with the intermediate section comprising approximately ¼ to ½ of the total length and the end sections being approximately equal to each other in length.

19. The malleable dental floss as in claim 17, further comprising an active substance functionally applied to the flossing material, said active substance comprising a substance from the group consisting of a flavorant, medicant, anti-bacterial agent, coagulant, fluoride compound, antibiotic, anti-inflammatory agent, anticalculus agent, desensitizing agent, local anesthetic agent and polishing agent.

20. The malleable dental floss as in claim 18, further comprising a packaging from the group consisting of a blister card, clam shell, shelf box, auto-bag, shrink wrap, cardboard box, soft covering, hard covering, glass container, polystyrene, sack, bag, jar, bottle, tube and bubble pack.
